(19) United States
(12) Patent Application Publication
(10) Pub. No.: US 2018/0257391 A1
(43) Pub. Date: Sep. 13, 2018

(54) IMAGE FORMING SYSTEM, IMAGE FORMING APPARATUS, AND IMAGE FORMING METHOD

(71) Applicant: SEIKO EPSON CORPORATION, Tokyo (JP)

(72) Inventor: Toshiaki KAKUTANI, Shiojiri (JP)

(21) Appl. No.: 15/899,890

(22) Filed: Feb. 20, 2018

(30) Foreign Application Priority Data
Mar. 10, 2017 (JP) 2017-046304

(51) Int. Cl. B41J 2/21

(52) U.S. Cl. CPC B41J 2/2132

(57) ABSTRACT

A block configured with Nb pixels included in image data is classified into Nt groups, position information which is information indicating a position of the pixel configuring is created, a block gradation value is decided by a data amount smaller than a data amount required for representing gradation values of the Nb pixels based on the gradation value for each pixel configuring each group, for each of the Nt groups, dot arrangement which is information indicating the presence or absence of dot formation for each pixel configuring the block is temporarily decided based on the block gradation value, for each of the Nt groups as the target, the dot arrangement targeting the block is decided by using the temporarily decided dot arrangement and the position information, and it is determined whether or not the dot arrangement decided by the dot arrangement deciding unit is corrected by using an error diffusion method.

### BACKGROUND

### 1. Technical Field

The present disclosure relates to image formation.

### 2. Related Art

In JP-A-2016-116105, a technology of generating dot data indicating the presence or absence of dot formation by performing a halftone process by combining a systematic dither method and an error diffusion method is disclosed. In this technology, with respect to the systematic dither method, a gradation value of each pixel is compared to a dither threshold value to determine the presence or absence of the dot formation, and the error diffusion method is performed in units of blocks formed of a plurality of pixels.

In a case of the related art described above, since the systematic dither method and the error diffusion method are performed, there is a problem that a processing time is prolonged. In order to reduce the processing time, when the method combined with the error diffusion method is changed to a method different from the general systematic dither method described above and then the method is performed in units of block the same as that of the error diffusion method, in a case where there is an edge within the block, image quality may be deteriorated due to resolution reduction.

### SUMMARY

An advantage of some aspects of the present disclosure is to achieve both a high-speed halftone process and suppression of the deterioration of the image quality in a method of realizing the halftone process by combining the error diffusion method.

According to an aspect of the disclosure, there is provided an image forming system including: a classifying unit that classifies a block configured with Nb pixels included in image data as a target into Nt (Nt is integer satisfying 2≤Nt<Nb) groups including a group including a pixel of the highest gradation value and a group including a pixel of the lowest gradation value; a position information creating unit that creates position information which is information indicating a position of the pixel configuring a group with respect to at least one of the Nt groups; a block gradation value deciding unit that decides a block gradation value by a data amount smaller than a data amount required for representing gradation values of the Nb pixels based on the gradation value for each pixel configuring each group, for each of the Nt groups as the target; a temporary deciding unit that temporarily decides dot arrangement which is information indicating the presence or absence of dot formation for each pixel configuring the block based on the block gradation value, for each of the Nt groups as the target; a dot arrangement deciding unit that decides the dot arrangement targeting the block by using the temporarily decided dot arrangement and the position information; a determining unit that determines whether or not the dot arrangement decided by the dot arrangement deciding unit is corrected by using an error diffusion method; a correcting unit that corrects the dot arrangement in a case where it is determined by the determining unit that the dot arrangement is corrected; and an image forming unit that forms an image by using the dot arrangement. According to the embodiment, it is possible to realize compatibility between high-speed halftone process and suppression of image quality deterioration. The reason why the halftone process is performed at high speed is that the dot arrangement deciding unit decides the dot arrangement in units of blocks. The reason why the deterioration of image quality due to resolution reduction is suppressed is that dot arrangement temporarily decided for each group is synthesized by using the position information.

In the embodiment, the determining unit may perform the calculation of an error and diffusion of the calculated error in the error diffusion method with the block as a unit. According to the embodiment, a processing load of the calculation of the error and the diffusion of the error is reduced as compared to an embodiment in which they are performed as a unit of pixels.

In the embodiment, the determining unit may perform the determination in a case where the number of the dots included in the dot arrangement decided by the dot arrangement deciding unit is equal to or less than a predetermined number. According to the embodiment, it is possible to simplify configurations of the determining unit and the correcting unit while effectively preventing disappearance or the like of fine lines of low density and to avoid deterioration of image quality due to excessive addition of dots.

In the embodiment, the correcting unit may select a pixel in which a dot is arranged from pixels included in a group including a pixel of the highest gradation value. According to the embodiment, pixels suitable for adding dots can be conveniently decided by using group classification.

In the embodiment, the correcting unit may randomly select arrangement of the dot in a pixel from the pixels included in the group including the pixel of the highest gradation value.

In the embodiment, the determining unit may determine whether or not the dot is arranged with respect to at least one pixel in which it is decided by the dot arrangement deciding unit that there is no dot formation, and the correcting unit may correct the dot arrangement by arranging the dot with respect to at least one pixel in which it is decided that there is no dot formation in a case where it is determined by the determining unit that the dot is arranged. According to the embodiment, it is possible to effectively prevent the disappearance of the fine lines of low density.

The present disclosure can be realized in various forms other than the above. For example, it can be realized in the form of an image forming method, an image forming apparatus realizing the method, a program for realizing the method, a non-temporary storage medium storing the program, and the like.

### BRIEF DESCRIPTION OF THE DRAWINGS

The invention will be described with reference to the accompanying drawings, wherein like numbers reference like elements.

FIG. 1 is a schematic diagram of an image forming system.

FIG. 2 is a flowchart showing a compressed data transmission process.

FIG. 3 is a flowchart showing a data compressing process.

FIG. 4 is a diagram showing a block.

FIG. 5 is a flowchart showing an image forming process.

FIG. 6 is a flowchart showing a halftone process.

FIG. 7 is a diagram showing large, medium, and small dot density conversion tables as a graph.

FIG. 8 is a table showing a relationship between a representative value and a block gradation value or the like.

FIG. 9 is a diagram showing threshold values applied to each pixel of a block to be focused.

FIG. 10 is a diagram showing a state of arranged dots of an H value group.

FIG. 11 is a diagram showing a state of a mask of the H value group.

FIG. 12 is a diagram showing a state of arranged dots of an L value group.

FIG. 13 is a diagram showing a state of the mask of the L value group.

FIG. 14A is a diagram showing a state of synthesis of a dot arrangement.

FIG. 14B is a flowchart showing an additional process.

FIG. 14C is a diagram showing a state in which a dot is added.

FIG. 14D is a diagram showing a state to which an error is diffused.

FIG. 15 is a diagram showing a gradation value of a certain ink color in image data (embodiment 2).

FIG. 16 is a diagram showing a relationship between the gradation value and a density pattern (embodiment 2).

FIG. 17 is a diagram showing dots generated in a case where the gradation value is 1.

FIG. 18 is a diagram showing dots generated in a case where the gradation value is 2.

FIG. 19 is a diagram showing dots generated in a case where the gradation value is 3.

FIG. 20 is a diagram showing dots generated in a case where the gradation value is 14.

FIG. 21 is a diagram showing dots generated in a case where the gradation value is 15.

FIG. 22 is a diagram showing dots generated in a case where the gradation value is 16.

FIG. 23 is a diagram showing a state of synthesis of a dot arrangement (embodiment 2).

FIG. 24 is a diagram showing a state of a dot arrangement (comparative example).

FIG. 25 is a schematic diagram of a printer (embodiment 3).

### DESCRIPTION OF EXEMPLARY EMBODIMENTS

### Embodiment 1

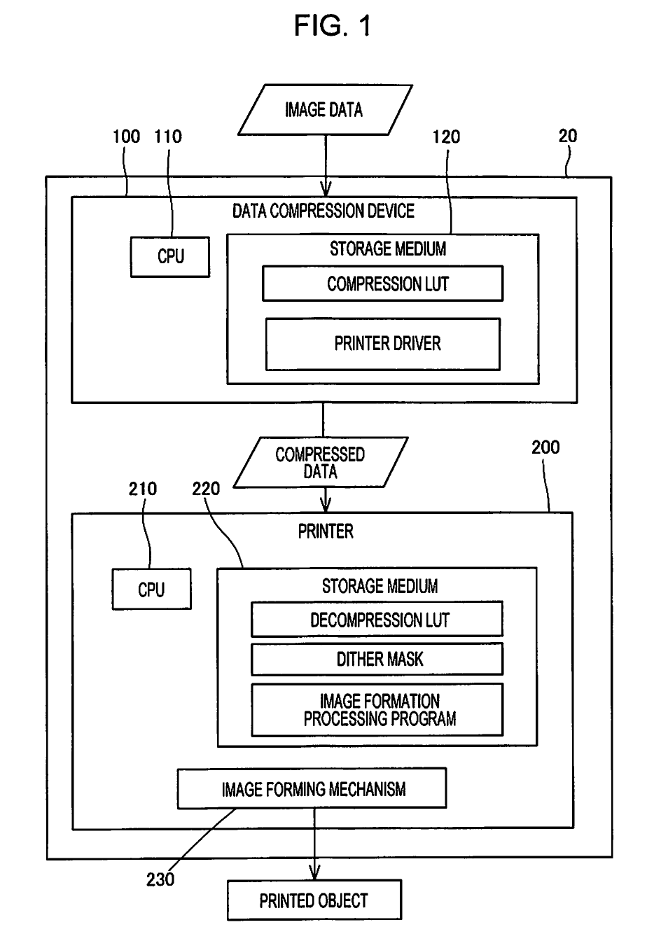

FIG. 1 schematically shows an image forming system 20. The image forming system 20 includes a data compression device 100 and a printer 200. The data compression device 100 creates compressed data by converting the image data. The compressed data is intermediate data obtained during a process of the halftone process of the image data. The data compression device 100 transmits the compressed data to the printer 200. Since the image forming system 20 includes the data compression device 100, the image forming system 20 also functions as a data compression system.

In the embodiment, the data compression device 100 is a personal computer. The data compression device 100 includes a CPU 110 and a storage medium 120. A compression LUT and a printer driver are stored in the storage medium 120. The storage medium 120 includes a RAM and performs temporal storing for performing the printer driver.

The printer 200 is an image forming apparatus. The printer 200 includes a CPU 210, a storage medium 220 and an image forming mechanism 230. A decompression LUT, a dither mask, and an image formation processing program are stored in the storage medium 220. The storage medium 220 includes a RAM, and performs temporal storing for performing the image formation processing program.

The image forming mechanism 230 is a generic term for hardware to form an image by an ink jet method. A printer head or the like is included in the image forming mechanism 230. The resolution of image formation by the printer 200 is 1,200 dpi. Ink colors used by the printer 200 are C (cyan), M (magenta), Y (yellow), and K (black). The printer 200 can select the size of each dot to be formed on a printing medium from three types of large, medium, and small.

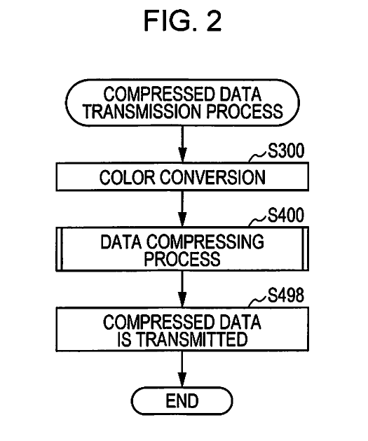

FIG. 2 is a flowchart showing a compressed data transmission process. A program stored in the data compression device 100 is realized by being executed by the CPU 110. The program is the printer driver.

The compressed data is created based on the image data indicated with an RGB value. In the embodiment, the resolution of the image data is 1,200 dpi. Data indicating a gradation value in each pixel is stored in the image data. In the embodiment, the gradation value is an integer value of 0 to 255.

When the compressed data transmission process starts, color conversion is performed (S300). That is, the RGB values are converted into C, M, Y, and K values of ink color components. The each of the C, M, Y, and K values also is an integer value of 0 to 255. After that, the same process is independently performed for each ink color component. Subsequently, a data compressing process is performed for each ink color component (S400), the compressed data is transmitted (S498), and then the compressed data transmission process is completed.

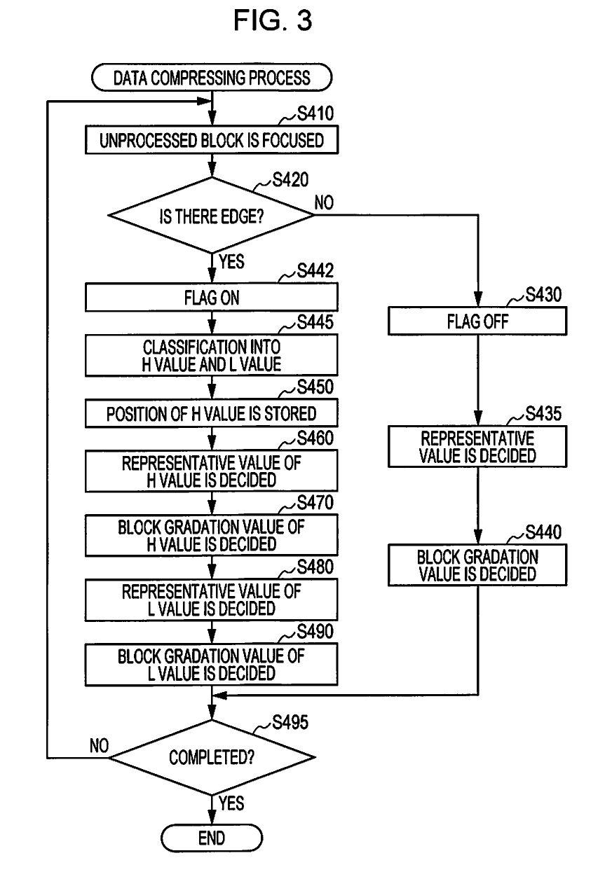

FIG. 3 is a flowchart showing a data compressing process of the ink color component of one color. First, one of unprocessed blocks is focused (S410).

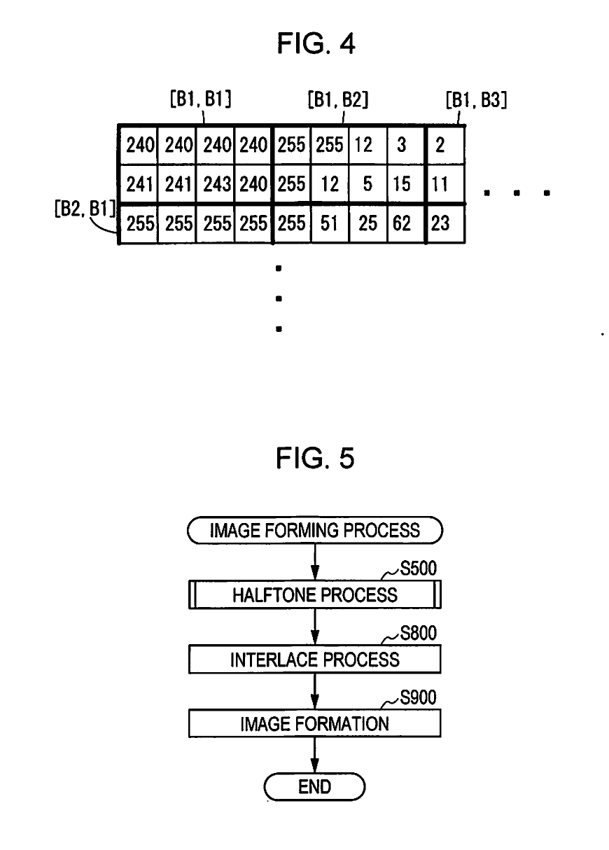

FIG. 4 is a diagram showing the block. The block is a cluster of Nb rectangles (eight in embodiment) surrounded by a bold rectangle. Each rectangle indicates a pixel. The number stored in the pixel indicates a gradation value of a certain ink color (for example, black).

The block is used as a pseudo-pixel in subsequent processes. Data compression is performed on each block of each ink color as one unit.

Subsequently, it is determined whether or not an edge is included in a focused block (hereinafter, referred to as focused block) (S420). S420 in the embodiment is performed based on whether or not the next equation is satisfied.

(maximum gradation value−minimum gradation value)≥threshold value (1)

The threshold value is 100 in the embodiment.

In a case of the block [B1, B1] shown in FIG. 4, the maximum gradation value is 243 and the minimum gradation value is 240. Therefore, Equation (1) is not satisfied and it is determined that the edge is not included. Meanwhile, in a case of the block [B1, B2], the maximum gradation value is 255 and the minimum gradation value is 3. Therefore, Equation (1) is satisfied and it is determined that the edge is included. The block [B1, B1] is a block positioned on the top left of the image, and the block [B1, B2] is a block positioned on the right side of the block [B1, B1]. As described above, a character string after the comma in a square bracket indicates a position in the main scanning direction, and the number following B indicates the number of blocks from the left end. In addition, a character string before the comma in the square bracket indicates a position in a sub-scanning direction, and the number following B indicates the number of the blocks from the top.

In a case where the edge is not included (S420, NO), a flag is set to OFF (S430). The fact that this flag is OFF indicates that no edge is included.

Subsequently, a representative value of the block is decided (S435). The representative value is also referred to as a group representative gradation value. In the embodiment, the representative value is calculated by the sum total of the gradation values included within the block. Hereinafter, if simply average, it means the sum total. The representative value is rounded off to the nearest whole number to an integer value in a case where the average includes the decimal point. For example, a case of the block [B1, B1], since the average is 240.625, the representative value is 241.

Subsequently, based on the representative value, the block gradation value is decided (S440). Conversion from the representative value to the block gradation value is realized by referring the compression LUT. However, the compression LUT is prepared for each position of the block, and in S440, the compression LUT corresponding to a position of the focused block is used.

The position of the block indicates a positional relationship with a dither mask. When it is assumed that a size of the dither mask is 64 pixels×64 pixels, in a case of an ordinary systematic dither method, by applying a threshold value stored in the dither mask for each block of 64 pixels×64 pixels, the arrangement of the dots is decided. As described above, in a case where it is assumed that the dither mask is applied, it is determined whether each block is disposed at any position in the dither mask. The position is called as the position of the block.

If the position of the block is determined, since the threshold value of a corresponding dither mask is determined, it is possible to investigate a halftone result in a case where the gradation value of all pixels within the block is the representative value with respect to all cases of the representative values from 0 to 255. The compression LUT is created based on the investigated result.

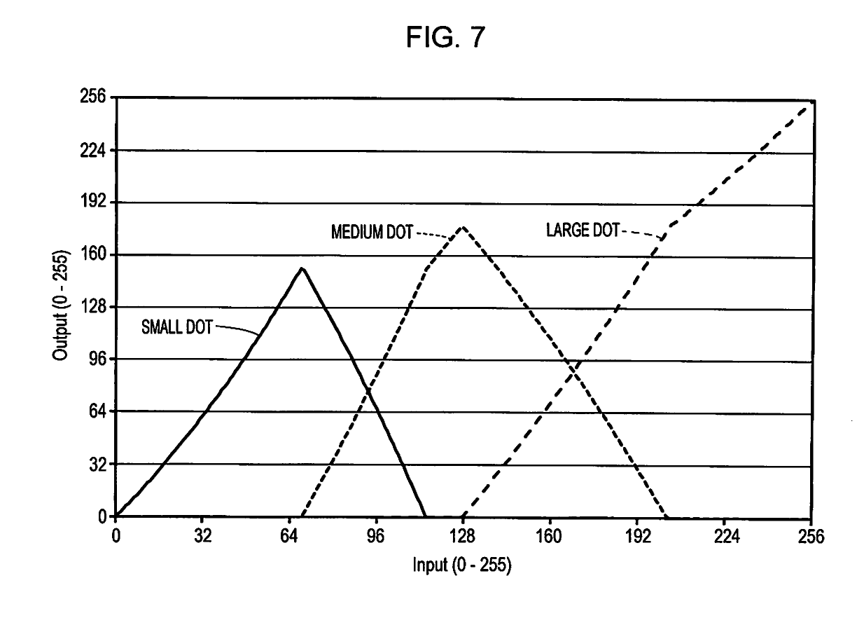

Hereinafter, a creation process of the compression LUT will be described. The ink color component: DATA of the integer value of a range of 0 to 255 is converted into density data: L_DATA, M_DATA, and S_DATA of large, medium, and small dot sizes by referring to large, medium, and small dot density conversion tables. FIG. 7 is a diagram showing large, medium, and small dot density conversion tables as a graph. When the conversion is represented by an Equation, it becomes as follows.

L_DATA=L_tb1 (DATA)

M_DATA=M_tb1 (DATA)

S_DATA=S_tb1 (DATA)

It is assumed that each of the large, medium, and small density data is the integer value of a range of 0 to 255 as ink color data. When the small dots are used up to nearly 100%, since the resistance to the deviation of a dot landing position or the like is lowered, the maximum density of the small dot is suppressed to approximately 60% as shown in FIG. 7.

It is assumed that a dither mask threshold value (integer of range of 0 to 254) of an investigation target pixel is THi. In this case, a halftone result in a case where input data is the DATA can be 4-valued into one of large, medium, small, and OFF by the following method when it is assumed that LM_DATA=L_DATA+M_DATA and T_DATA=LM_DATA+S_DATA.

(L_DATA>THi), then the large dot is ON

(L_DATA≤THi<LM_DATA), then the medium dot is ON

(LM_DATA≤THi<T_DATA), then the small dot is ON

(T_DATA≤THi), then the dot is OFF

With respect to the dither mask threshold values: TH0 to TH7 of eight pixels in the position of the block of an investigation target, when the halftone result in a case where DATA values range from 0 to 255 is investigated in advance, all dot arrangements within the block in a case where all pixels within the block have the same DATA value become clear.

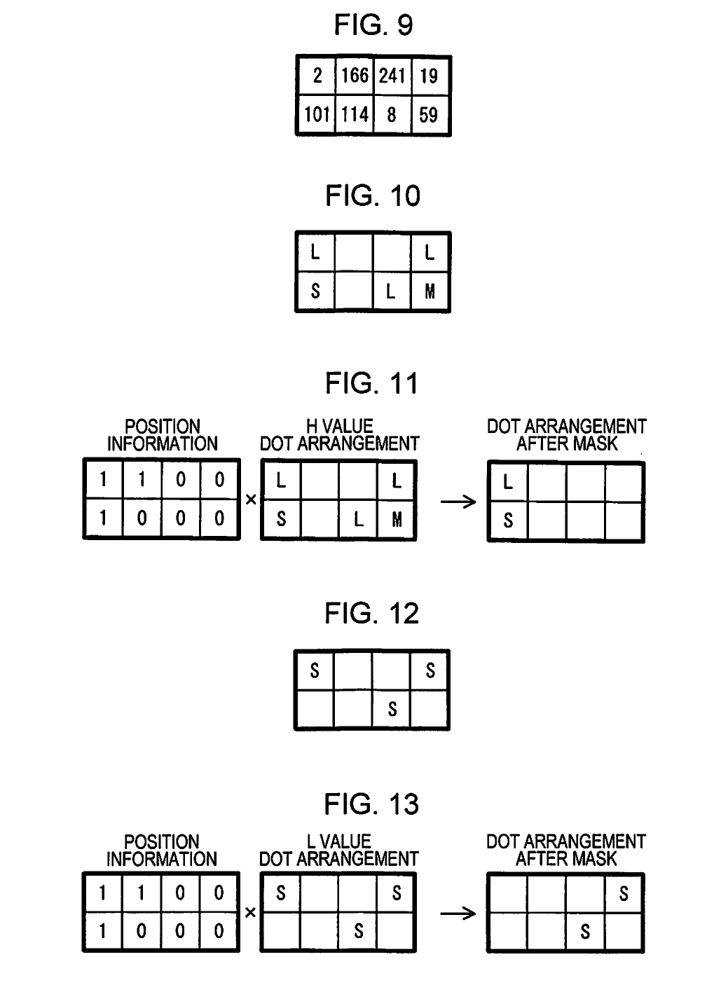

FIG. 9 is a diagram showing threshold values applied to a position of each pixel of the block to be focused. The printer 200 stores a general dither mask used for the systematic dither method. The threshold value shown in FIG. 9 is a part of the dither mask, and indicates threshold values applied to the block to be focused. The contents of FIG. 9 are also used for explanation (which will be described below) of decision of the dot arrangement using the decompression LUT.

In an example of FIG. 9, the dither mask threshold values of the position of an investigation target block are set as TH0=2, TEI=166, TH2=241, TH3=19, TH4=101, TH5=114, TH6=8, and TH7=59.

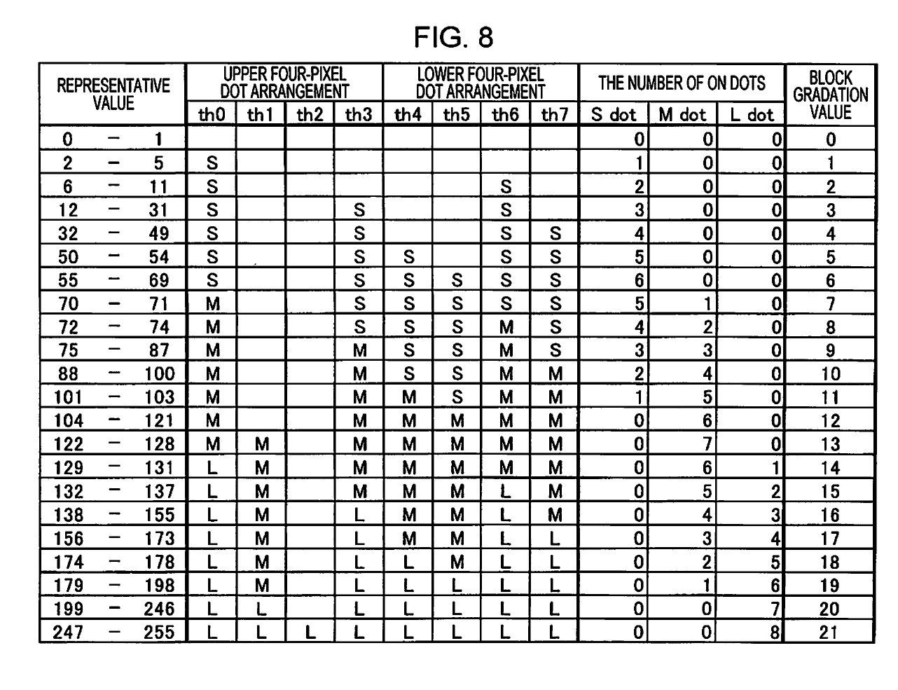

Based on an investigated result on this case, in a case where input DATA increases from 0 to 255 by one, a method of the combination of the dot arrangement within the block and the number of generations of each of large, medium, and small dots within the block corresponding thereto is tabulated. The dot arrangement within the block is an ON or OFF result of each of large, medium, and small dots with respect to each pixel position of TH0 to TH7. Furthermore, when counting whether the dot arrangement as the block gradation value corresponds to a stage of change, the table shown in FIG. 8 can be created with respect to the block position.

A corresponding part from the representative value to the block gradation value of the table shown in FIG. 8 is the compression LUT. By referring the compression LUT, it is possible to convert the representative value into the block gradation value.

FIG. 8 shows that the block gradation values are changed in 22 stages from 0 to 21 in a case where the representative value increases from 0 to 255 by one. In this case, a fact that the representative value is a (any one of 0 to 255) means that a is input to all pixels within the block. A fact that the block gradation values are changed in 22 stages means that there are 22 combinations of the large, medium, and small dots in a target block. Furthermore, in the method of the embodiment, since the dot arrangement within the block corresponding to the block gradation value is also determined to be one, the dot arrangements itself are changed in the 22 stages.

The table shown in FIG. 8 can be used for the purpose of obtaining the final halftone result from the block gradation value. The final halftone result is the dot arrangement within the block. In this case, from the block gradation value, a corresponding relationship to a dot on or off result of the pixel positions of 4×2=8 pixels in total by 4 pixels above and below may be referred.

Since the compression LUT in the embodiment depends on the dither mask threshold value within the block, it is prepared for each position of the block. In this case, since the maximum value of block gradation value also depends on the dither mask threshold value within the block, different values can be taken for each block.

For example, when the same investigation is performed with respect to a case of TH0=240, TH1=65, TH2=120, TH3=90, TH4=17, TH5=168, TH6=212, and TH7=30, the block gradation values are changed in 20 stages from 0 to 19, and all eight pixels within the block become large dot ON in a case of the block gradation value 19.

Meanwhile, a combination of six of the large dot and one of the medium dot corresponds to the block gradation value 19 in an example of the table of FIG. 8. As described above, since the combination of the dots corresponding to the block gradation value depends on the dither mask threshold value within the block, the halftone result may differ by the position of the block even in the same block gradation value.

The maximum value of block gradation value also depends on the large, medium, and small dot density conversion table shown in FIG. 7, and in a case of the large, medium, and small dot density conversion table having complicated characteristics, the maximum value of block gradation value becomes large sometimes. However, in a case of the large, medium, and small dot density conversion table having practical characteristics, there is no case where the maximum value of block gradation value exceeds 31 as long as the number of pixels configuring one block is 8 pixels. Accordingly, it is sufficient to allocate 5 bits as the block gradation value.

If a case where the maximum value of block gradation value exceeds 31 occurs, as a result, it is possible to correspond the dither mask or the large, medium, and small dot density conversion tables by correcting them so as to be the maximum value of block gradation value within 31 or less. As described above, the block gradation value in the embodiment can be represented by a data amount of 5 bits.

Meanwhile, in a case where the edge is included (S420, YES), the flag is set to ON (S442). Next, the pixels included in the block to be focused are classified into an H value group and an L value group (S445).

In a case where the gradation value of the pixel group configuring the block is divided into a high value and a low value, the H value group is a group configured with the pixel (hereinafter, H value pixel) having the gradation value classified as the high value. Meanwhile, the L value group is a group configured with the pixel (hereinafter, L value pixel) having the gradation value classified as the low value.

In the embodiment, as a criterion for a classification of the H value group and the L value group, an average of the maximum gradation value and the minimum gradation value is used. For example, in a case of the block [B1, B2] shown in FIG. 4, an average of the maximum gradation value 255 and the minimum gradation value 3 is 129. Therefore, three pixels of the gradation value 255 are classified as the H value group. The H value group naturally includes the pixel of the maximum gradation value. Meanwhile, the pixels of the gradation values 3, 5, 12, and 15 are classified as the L value group. The L value group naturally includes the pixel of the minimum gradation value. In a case where it coincides with the average, it is classified as the H value group in the embodiment. In another case, it may be classified as the L value group.

Next, a position of the H value pixel is stored (S450). Information stored in 5450 is referred hereinafter to as position information. 1 indicating the H value pixel for each pixel or 0 indicating the L value pixel is stored in the position information.

Next, the representative value of the H value group is decided (S460). In the embodiment, the representative value of the H value group is calculated as an average of the gradation value of the H value pixel.

Subsequently, the block gradation value of the H value group is decided (S470). In a deciding method in S470 is the same as that of S440.

Next, the representative value of the L value group is decided (S480). In the embodiment, the representative value of the L value of group is calculated as the gradation value of the L value pixel.

Subsequently, the block gradation value of the L value group is decided (S470). In a deciding method in S470 is the same as that of S440.

In a case where there is such an edge, the information of the block gradation values of two of the flag and the position information is generated.

After S440 or S490, it is determined whether all blocks are processed (S495). In a case where there is an unprocessed block (S495, NO), the process returns to S410. In a case where all blocks are processed (S495, YES), the data compressing process is completed. The data processed in this manner is the compressed data.

As explained in FIG. 3, the compressed data is generated by the decision of the representative value and compression of two stages of conversion to the block gradation value. Therefore, it is possible to grasp that the representative value is first compression gradation value and the block gradation value is second compression gradation value. Then, it is possible to grasp that data including the representative value and the position information is first compressed data, and data including the block gradation value and the position information is second compressed data. However, in a case where simply referred to as the compressed data in the embodiment, it refers to as the second compressed data.

Next, the image forming process will be described by using FIG. 5. The image forming process is performed by a CPU 210 when the compressed data is received.

First, the halftone process (which will be described below) is performed (S500). Subsequently, an interlace process is performed on dot data obtained by the halftone process (S800), and image formation is performed (S900).

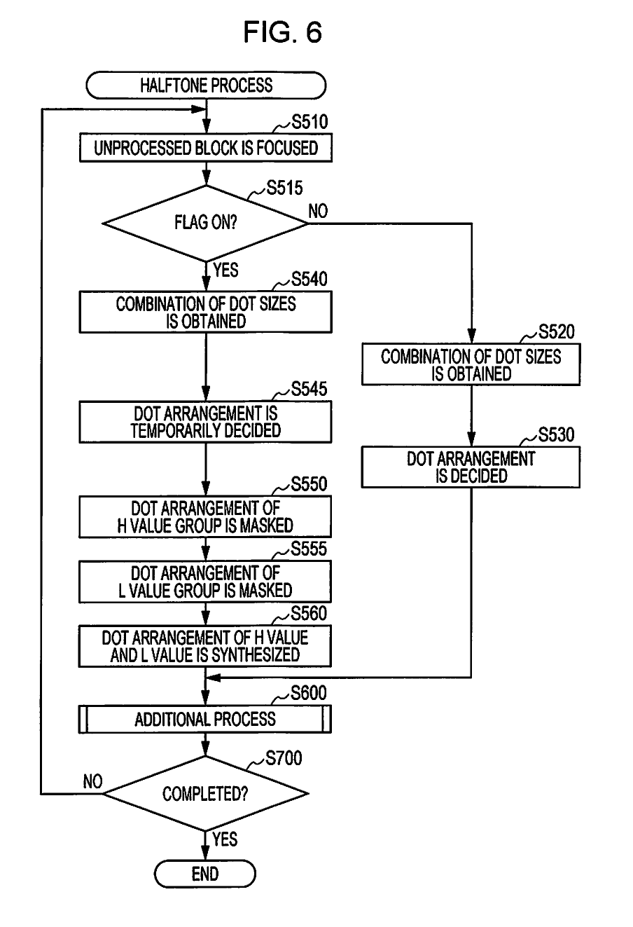

FIG. 6 is a flowchart showing the halftone process. First, one of unprocessed blocks is focused (S510). S510 is the same process as S410.

Subsequently, it is determined whether the flag is ON (S515). In a case where the flag is OFF (S515, NO), a combination of dot sizes is obtained from the block gradation value of the block to be focused (S520).

The printer 200 stores the relationship between the block gradation value and the combination of dot sizes for each position of the block among contents of the table shown in FIG. 8. They are collectively called as the decompression LUT.

If the block gradation value and the position of the block are given, the number of the dots of each size, that is, the combination of dot sizes can be obtained by using the decompression LUT.

Next, the dot arrangement in the block to be focused is decided (S530), and the process proceeds to S600. In S530, the combination of dot sizes obtained in S520 and the dither mask are used.

For example, in a case where the combination of dot sizes is three large dots, one medium dot, and one small dot, large dots are arranged for pixels with first to third small values, medium dots are arranged in pixels with the next small values, and small dots are arranged in pixels with the next small values among the threshold values. In the example of FIG. 9, the large dots are arranged in the pixels of the threshold values 2, 8, and 19, the medium dot is arranged in the pixel of the threshold value 59, and the small dot is arranged in the threshold value 101.

Originally, the dither mask is used to decide the presence or absence of dot formation by comparing the stored threshold value and the gradation value of each pixel in the image data. It is possible to grasp that the threshold value stored in the dither mask indicates a priority order of the dot formation depending on a viewpoint. That is, it is possible to grasp that the systematic dither method is a method of requiring that dots are formed preferentially as the pixel with a low numerical value as the threshold value of the dither mask. In S530, this feature is utilized.

FIG. 10 shows a state of dots arranged in this manner. L indicates the large dot, M indicates the medium dot, and S indicates the small dot. A combination of three large dots, one medium dot, and one small dot does not present in the table of FIG. 8. However, this is given as an example so as to explain the most complicated case where large, medium, and small are ON at the same time.

Meanwhile, a case where the flag of the block to be focused is ON (S515, YES), with respect to each of the block gradation value of the H value group and the block gradation value of the L value group, the combination of dot sizes is obtained (S540). An obtainment method is the same as that of S520.

Subsequently, with respect to each of the H value group and the L value group, the dot arrangement is decided (S545). A decision method is the same as that of S530.

Next, the dot arrangement of the H value group is masked by using the position information (S550). In order to describe the mask, it is assumed that the dot arrangement shown in FIG. 10 is the dot arrangement of the H value group. Then, the position of the H value group is the position of three gradation values 255 included in the block [B1, B2] shown in FIG. 4. The dot arrangement of the H value group shown in FIG. 10 is a result obtained by using and arranging the threshold values shown in FIG. 9 in a case where the combination of dot sizes is two large dots, one medium dot, and one small dot.

FIG. 11 is a diagram showing a state of the mask of the H value group. As described in FIG. 11, in a case of the H value group, the dot of the pixel in which 1 as the position information is stored remains, and the dot of the pixel in which 0 as the position information is stored is deleted. As a result, one large dot and one small dot remain. This calculation is called as the mask in the embodiment.

Next, the dot arrangement of the L value group is masked by using the position information (S555). In order to describe the mask, it is assumed that the dot arrangement shown in FIG. 12 is the dot arrangement of the L value group. Then, the position of the L value group is a position other than the gradation values 255 included in the block [B1, B2] shown in FIG. 4. The dot arrangement of the L value group shown in FIG. 12 is a result obtained by using and arranging the threshold values shown in FIG. 9 in a case where the combination of dot sizes is no large dot, no medium dot, and three small dots.

FIG. 13 is a diagram showing a state of the mask of the L value group. As described in FIG. 13, in a case of the L value group, the dot of the pixel in which 0 as the position information is stored remains, and the dot of the pixel in which 1 as the position information is stored is deleted. As a result, two small dots remain.

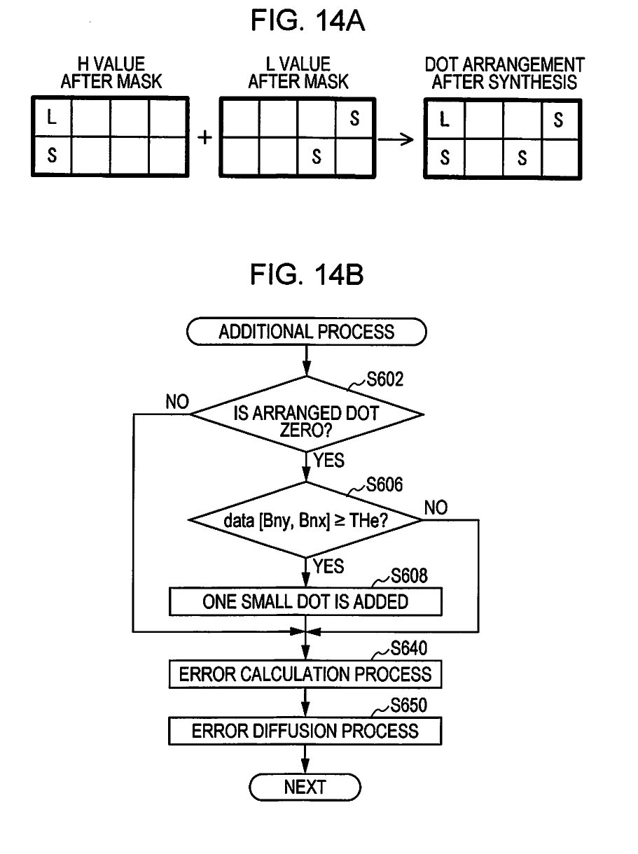

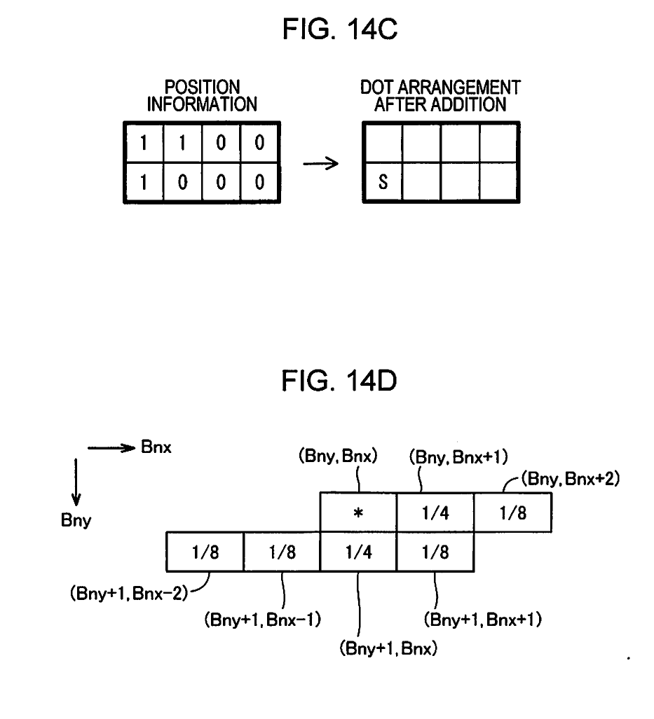

Subsequently, the dot arrangement of the H value group and the L value group is synthesized (S560), the process proceeds to S600. FIG. 14A shows a state of the synthesis of the dot arrangement.

As illustrated in FIG. 14A, in the pixel in which the dots are arranged in any one of the dot arrangement of the H value group after the mask and the dot arrangement of the L value group after the mask, the dots are arranged as they are after the synthesis. Meanwhile, the dots are not arranged in the pixel in which the dots are arranged in both the dot arrangement of the H value group after the mask and the dot arrangement of the L value group after the mask. The pixel in which the dots are arranged in both the dot arrangement of the H value group after the mask and the dot arrangement of the L value group after the mask does not present due to the characteristics of the mask.

When proceeding to S600, an additional process is performed. The details of this process are represented in FIG. 14B. When the additional process shown in FIG. 14B starts, it is determined whether the number of the dots arranged as a result of S530 or S560 is zero (S602).

In a case where the number of the arranged dots are one or more (S602, NO), an error calculation process (S640) and an error diffusion process (S650) are performed. S640 and S650 will be described below.

Meanwhile, in a case where the number of the arranged dots is zero (S602, YES), it is determined whether or not an error diffusion gradation value of the block to be focused is a threshold value THe or more in the error diffusion method (S606). The error diffusion gradation value will be described below.

Hereinafter, the block to be focused is represented by the block [Bny, Bnx]. As described above, ny is a natural number indicating a position in the sub-scanning direction and nx is a natural number indicating a position in the main scanning direction.

In the embodiment, in order to simplify the process, only small dots are supplemented by the error diffusion method. Even if only small dots are supplemented, sufficient effects can be obtained to solve problems such as disappearance of thin lines of low density. At this time, in the error diffusion method, the number of generation of the small dot by the dither method is monitored, and the small dots are supplemented in a case where it is determined that that is insufficient.

In the embodiment, as the error diffusion gradation value of the block to be focused, data that is corrected by adding the error diffused from a neighboring processed block to the sum of small dot density data within the block is used. An error diffusion gradation value data [Bny, Bnx] is expressed by the following Equation.

data[Bny, Bnx]=ΣS_DATA+ed[Bny, Bnx] (2)

ΣS_DATA in Equation (2) is the sum of the small dot density data of the pixel included in the block to be focused. ed [Bny, Bnx] in Equation (2) is an error diffused from the neighboring processed block with respect to the block to be focused.

In the embodiment, the threshold value THe is not a value (median value of gradation range) used in normal error diffusion but a value that varies according to an average value: S_MEAN of the small dot density data of the block to be focused.

S_MEAN=ES DATA/Nb

THe=(S_MEAN·W+255/2)/(W+1)

If W=0, it is the threshold value of a usual error diffusion method which is fixed to the median value of a gradation range, but W=4 and straight line characteristics are set to a rightward rising in the present embodiment. With this, the delay of the dot generation or the like is improved when the dot density is small. Next, data [Bny, Bnx] and THe are compared and if data [Bay, Bnx] is equal to or larger than the threshold value THe (S606, YES), one small dot is additionally arranged within the block to be focused (S608).

The pixel in which the small dot is arranged is randomly decided from the pixel within the block in the embodiment in a case where an edge flag is OFF. In a case where priority is given to the image quality rather than a processing speed, the dither mask threshold value in FIG. 9 may be decided to be the pixel having the smallest value within the block. If the threshold value of the dither mask is small, the dot is easily formed on the corresponding pixel, the characteristics held by the dither mask can be easily reflected.

In a case where the edge flag is ON, the block to be focused is randomly decided from the pixel classified as the H value group in the embodiment, but the threshold value of the dither mask shown in FIG. 9 may be decided as the smallest pixel among the pixel classified as the H value group. FIG. 14C is a diagram showing a state in which one small dot is additionally arranged in a case where the edge flag is ON.

Meanwhile, if data [Bny, Bnx] is less than the threshold value THe (S606, NO), the addition of the small dot is not performed by skipping S608.

In a case where it is determined that it is NO in S602, a case where it is determined that it is NO in S606, or after S608 is performed, the error calculation process (S640) and the error diffusion process (S650) are performed.

In the error calculation process (S640), error ed [Bny, Bnx] occurred from the block to be focused is obtained. The error ed [Bny, Bnx] is obtained by the following Equation.

ed[Bny, Bnx]=data[Bny, Bnx]−Con·ONv (3)

On-value ONv is a dot density data value corresponding to one dot, and is 255 corresponding to the dot density 100% in the embodiment.

A counter Con indicates the number of the small dots formed within the block to be focused. Accordingly, in a case where it is determined that it is NO in S602, the error ed [Bny, Bnx] of the block to be focused becomes a value obtained by subtracting a multiplication value of the number of the small dots Con and an on-value formed within the block from data [Bny, Bnx] of the block to be focused. In a case where S608 is performed, the error ed [Bny, Bnx] becomes a value obtained by subtracting the on-value of one dot from data [Bny, Bnx] of the block to be focused. In a case where it is determined that it is NO in S606, the error ed [Bny, Bnx] becomes data [Bny, Bnx] of the block to be focused.

In a case where it is determined that it is NO in S606, Con·ONv=0 not to form the dot such that data [Bny, Bnx] including error diffused from neighboring blocks becomes the error ed [Bny, Bnx] as it is.

As remaining two cases, there is a case where a calculated result is smaller than zero. In this case, the error of a negative value is diffused to the neighboring block.

Next, the error diffusion process (S650) of distributing the obtained error ed [Bny, Bnx] to the neighboring block is performed.

FIG. 14D shows a state in which an error is diffused. In a case of diffusing the error occurring in the block to be focused [Bny, Bnx] marked with *, the error ed [Bny, Bnx] calculated in S640 in this block is diffused to the six neighboring blocks. All of these six blocks are unprocessed blocks. In the embodiment, in the first step S510, the top left block of the image is focused, and in the next step S510, the block adjacent to the immediately preceding block to be focused in the main scanning direction (that is, right adjacent block) is focused. When it is processed to the right end in the main scanning direction, the position in the sub-scanning direction is moved by one block and it is sequentially performed from the left end again. Therefore, the block to the right of the block to be focused is an unprocessed block. The block below the block to be focused is also the unprocessed block.

The ratio of distribution is 1/4 for the block immediately to the right of the block to be focused (next focused block) and for the block immediately below, and 1/8 for the other four blocks. Specifically, as ratios of

1/4 for the block (Bny, Bnx+1)

1/8 for the block (Bny, Bnx+2)

1/8 for the block (Bny+1, Bnx−2)

1/8 for the block (Bny+1, Bnx−1)

1/4 for the block (Bny+1, Bnx)

1/8 for the block (Bny+1, Bnx+1),

the error ed [Bny, Bnx] is distributed and the error diffusion is performed.

The error distributed in this manner is added and stored in a diffusion error buffer prepared for each block and stored and used for an additional process in each block. The additional process is completed, and the process proceeds to S700.

In S700, it is determined whether the processes on all blocks are completed. In a case where there is an unprocessed the block (S700, NO), the process returns to S510. In a case where the processes on all blocks are completed (S700, YES), the halftone process is completed. In this way, by the halftone process, the dot data indicating the dot arrangement of each ink color for all pixels is obtained. The dot arrangement is information indicating the presence or absence of the dot formation for each pixel. In the embodiment, the dot arrangement is information indicating the size of the dot in a case where there is the dot formation.

According to the embodiment, it is possible to obtain at least the following effects.

(a) A processing load for obtaining the dot data from the image data is small. This is because, after deciding the representative value, the dot arrangement can be decided or temporarily decided by simply referring to the compression LUT, the decompression LUT, and the dither mask.

(b) In a case where there is an edge within the block, since the dot arrangement is decided by synthesizing the two temporarily decided dot arrangements, degradation of image quality is suppressed.

(c) It is possible to perform the decision of the block gradation value and the obtainment of the dot arrangement in which the block gradation value is used by sharing them in the data compression device 100 and the printer 200. Therefore, it is possible to reduce the processing load in the data compression device 100. Also, it is difficult for an image formation speed to become slow.

(d) Even in a case where the number of the dots decided by using the block gradation value and the mask is zero, for example, a case where dots are formed such as where the thin lines of low density are drawn on the image may contribute to improvement in the image quality. Formation of such dots can be realized by an additional process using the error diffusion method.

(e) In a case of the (d), since the error diffusion process is performed on a block unit, it is possible to reduce a calculation process of the error diffusion, and shorten a processing time.

(f) Since the maximum number of dots formed by the additional process is one within the block, it is possible to suppress the number of the dots to be formed additionally.

(g) In a case where the dots are additionally formed, since the pixel forming the dot is selected from the pixel of the H value group, the image quality is improved as compared to a case in which the dots are arranged in the pixels of the L value group.

(h) In a case of the (g), since the pixel forming the dot is randomly selected from the pixels of the H value group, processing for selection is simple and it is suppressed that the halftone process is delayed by the additional process. In the embodiment, although only one small dot is generated in the error diffusion process, two or more small dots may be generated. For example, another threshold value THe 2 (for example, THe 2=THe+255) larger than THe other than THe is provided, if data [Bny, Bnx]≥THe 2, two small dots are additionally generated, and if THe>data [Bny, Bnx]≥THe 2, one small dot is additionally generated. The position to be arranged may be randomly decided.

In the embodiment, only the small dot density data is a target of the error diffusion process, but T_DATA which is the sum of large, medium, and small dot density data may be targeted instead of the small dot density data. This is a consideration on all of large, medium, and small dots, but this is a method that gradation difference of the large, medium, and small dots is ignored and it is handled as if all are the small dots so as to simplify the process. At this time, if data [Bny, Bnx]=ΣT_DATA+ed [Bny, Bnx] is used instead of Equation (2) and the counter Con is the sum of the number of the large, medium, and small dots formed within the block to be focused, other parts may be the same as those of embodiment 1. In this method, it is assumed that the error diffusion method monitors the total number of the large, medium, and small dots by the dither method, and the small dots are supplemented in a case where it is determined that it is insufficient.

Furthermore, as another method, it is also possible to more precisely calculate the error in consideration of the difference in the gradation value of the large, medium, and small dots. For example, in a case where the medium dot corresponds to two small dots and the large dot corresponds to four small dots, on-value values ONv_L, ONv_M, and ONv_S of the large, medium, and small dots become ONv_L=4ONv, ONv_M=2·ONv, and ONv_S=ONv, respectively, such that Equation (2) and Equation (3) may be changed as follows.

data[Bny, Bnx]=ΣS_DATA+2·ΣM_{DATA}+4·ΣL_DATA+ed [Bny, Bnx]

ed[Bny, Bnx]=data[Bny, Bnx]−Con_S·ONv_S−Con·ONv_M−Con_L·ONv_L

Here, Con_S is the number of the small dots formed within the block to be focused, Con_M is the number of the medium dots, and Con_L is the number of the large dots.

In this method, it is also possible to generate two or more types of dots such as the small dot and the medium dot. For example, the threshold value THe 2 (example: THe 2=THe+255) larger than THe other than THe is provided, if data [Bny, Bnx] THe 2, one medium dot may be additionally generated, and if THe≥data [Bny, Bnx] THe 2, one small dot may be additionally generated.

In addition, at this time, if THe=THe 2, only the medium dot is generated without generating the small dot.

As described above, in a case where ejection of the small dots is unstable and they are not used much or the like, it is possible to additionally generate only the medium dot. In the embodiment, the additional dot is generated only when it is determined as YES in S602, but in a case of NO in S602, that is, even in a case where one or more dots are already generated within the block, the process may proceed to steps after S606, and the dot may be additionally generated by the error diffusion method. With this, it is possible to more aggressively perform additional dot generation by the error diffusion method. In a case of NO in S602, the newly added dot may be arranged at the pixel position excluding the pixel in which the dots are already arranged, but it is possible to perform a method in which the additional arrangement of small dots being overlapped with the pixel in which the small dots are already arranged is allowed such that the pixel overlapped with two small dots is replaced with one medium dot, or the like.

In addition, generation of the additional dot in NO in S602 may be limited in the block in which it is determined that there is the edge in S420. Since an edge portion is a weak point in the dither method, by doing so, compatibility with the dither method can be enhanced in a portion other than the edge portion while improving the image quality of the edge portion in a wider gradation region.

In the embodiment, the block including the edge is grouped into two groups of the H value group and the L value group, but the block may be grouped into three groups including an M value group having an intermediate gradation value. For example, the pixel less than the gradation value 85 is set to the L value group, the pixel equal to or greater than 85 and less than 170 is set to the M value group, and the pixel equal to or greater than 170 is set to the H value group. Even if the number of groups increases to three, the process of obtaining the representative value for each group, masking the dot arrangement obtained from the representative value according to the pixel position of each group, and synthesizing the result, is not changed. In addition, the dot additionally generated by the error diffusion may be arranged in the pixel of the H value group, may be in the pixel other than the L value group, or the like. Increasing the number of groups makes processing complicated, but it is possible to suppress a decrease in resolution when the number of pixels configuring the block increases.

### Embodiment 2

Description of an embodiment 2 is mainly directed to points different from the embodiment 1. The contents which are not explicitly described are the same as those of the embodiment 1. The description of an embodiment 3 which will be described below is mainly directed to points different from the embodiment 1, and contents not explicitly described are the same as those of the embodiment 1.

In the embodiment 2, there is only one type of a dot size. That is, S=2. In the embodiment 2, a size of the block is set to 4 pixels×4 pixels=16 pixels.

The data compressing process in the embodiment 2 will be described. In the embodiment 2, the block gradation value is set to 17 gradations from 0 to 16.

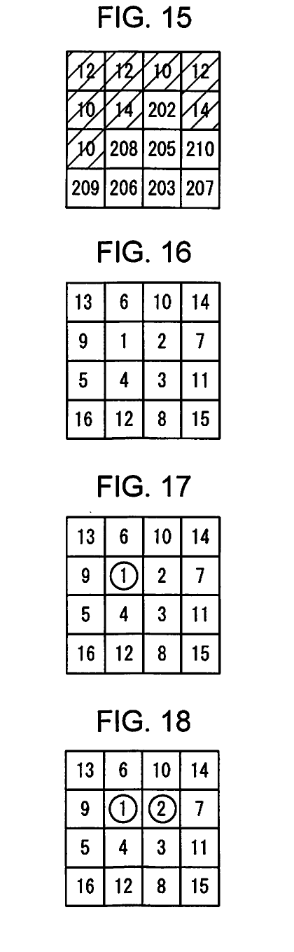

FIG. 15 is a diagram showing a gradation value of a certain ink color in image data. FIG. 15 shows an excerpt of one block from the entire image data.

In a case of an example shown in FIG. 15, since the maximum gradation value is 210 and the minimum gradation value is 10, it is determined that there is the edge (S420, YES). The average of the maximum gradation value and the minimum gradation value is 110. Hatching is performed on the L value pixel. An average of the gradation value of the H value group is 206.25. An average of the gradation value of the L value group is 11.75.

An average of the gradation value of all pixels is 109. An average of all pixels is used in the following description for a comparison with known methods.

In S470 and S490, in order to convert the above average to a block gradation value of 17 gradations from 0 to 16, the above average value is multiplied by 16/255 and then it is made into an integer. However, when it is simply converted to an integer by rounding off or the like, a false contour due to the fact that only 17 gradations can be reproduced is generated.

In the embodiment, in order to suppress the false contour as much as possible, a random number: rand ( ) of equal to or greater than 0 and less than 1 is generated for each block, after adding it, and it becomes an integer by truncating the decimal part. For example, it is assumed that a rand ( ) value of this block is 0.324. When an operator that rounds down to the nearest integer by truncating the decimal part is expressed as INT ( ) the H value group and the L value group are calculated as follows.

H value group=INT(206.25×16/255+0.324)=13

L value group=INT(11.75×16/255+0.324)=1

When the same calculation is performed by using an average 109 of all pixels, it becomes as follows.

gradation value of all blocks=INT(109×16/255+0.324)=7

Next, in the embodiment, the halftone process will be described. In the embodiment, the dot arrangement is obtained by using a density pattern method instead of S520 and S540.

Since resolution of image formation of the printer 200 is 1,200 dpi, the resolution decreases to 1/4 in both vertically and horizontally instead of reproducing 17 gradations depending on the block gradation value. Accordingly, it is possible to implement image formation in which 17 gradations at 300 dpi can be reproduced.

FIG. 16 shows a relationship between the gradation value and the density pattern. The pixel in which the dot is formed is a pixel in which a number equal to or less than the block gradation value is stored. That is, dots are generated preferentially for pixels in which small numbers are stored. In the embodiment, a dot concentration type is adopted.

FIG. 17 shows that one dot is generated in a case where the block gradation value is 1. The pixel in which the dot is generated is indicated by a circle. The pixel in which the dot is generated is the pixel in which 1 as the threshold value is stored. Since it is the dot concentration type, the pixel in which 1 to 4 is stored as the threshold value is an internal pixel. Internal pixels are four pixels not adjacent to other blocks.

FIG. 18 shows that two dots are generated in a case where the block gradation value is 2. The pixel in which the dots are generated is a pixel in which a threshold value equal to or less than 2 is stored.

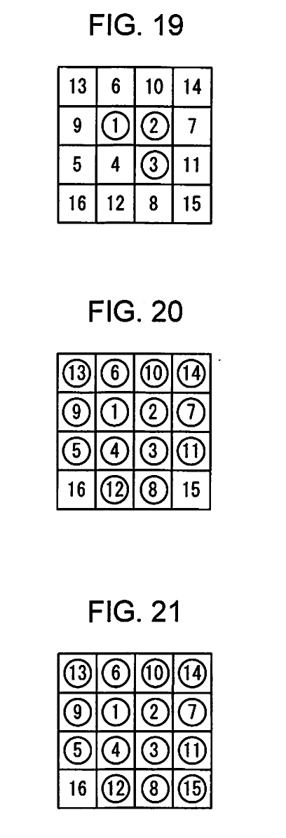

FIG. 19 shows that three dots are generated in a case where the block gradation value is 3. The pixel in which the dots are generated is a pixel in which the threshold value equal to or less than 3 is stored.

FIG. 20 shows that 14 dots are generated in a case where the block gradation value is 14. The pixel in which the dots are generated is a pixel in which the threshold value equal to or less than 14 is stored.

FIG. 21 shows that 15 dots are generated in a case where the block gradation value is 15. The pixel in which the dots are generated is a pixel in which the threshold value equal to or less than 15 is stored.

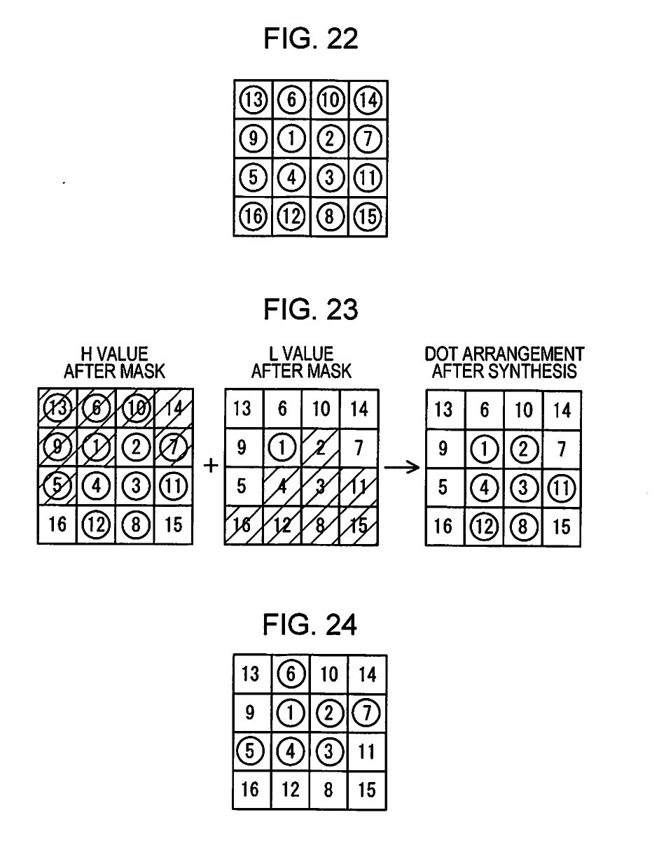

FIG. 22 shows that 16 dots are generated in a case where the block gradation value is 16. The pixel in which the dots are generated is a pixel in which the threshold value equal to or less than 16 is stored. That is, the dots are generated in all pixels.

FIG. 16 can be regarded as a diagram showing that no dot is generated in a case where the block gradation value is 0.

FIG. 23 shows a state of synthesis (S560) of the dot arrangement of the H value group and the L value group. The circle is indicated on the pixel on which the dot is formed. The hatching is performed on the masked pixel.

FIG. 24 is a diagram showing a state of the dot arrangement in a case where the gradation values of all blocks are used, as a comparative example. When FIG. 15, FIG. 23, and FIG. 24 are compared to each other, it can be seen that the dot arrangement method according to the embodiment has higher image reproducibility than the dot arrangement of the comparative example.

As described above, in the embodiment, the dot formation using the density pattern method is performed instead of the dither method in the embodiment 1. Then, the processes of further supplementing the dot in the error diffusion method are the same as those of the embodiment 1. However, in the embodiment, since there is only one type of the dot size, the medium dot, the density data and the large dot density data in the embodiment 1 may be always set to zero, and the small dot density data of the embodiment 1 may be gradation value data in the embodiment.

### Embodiment 3

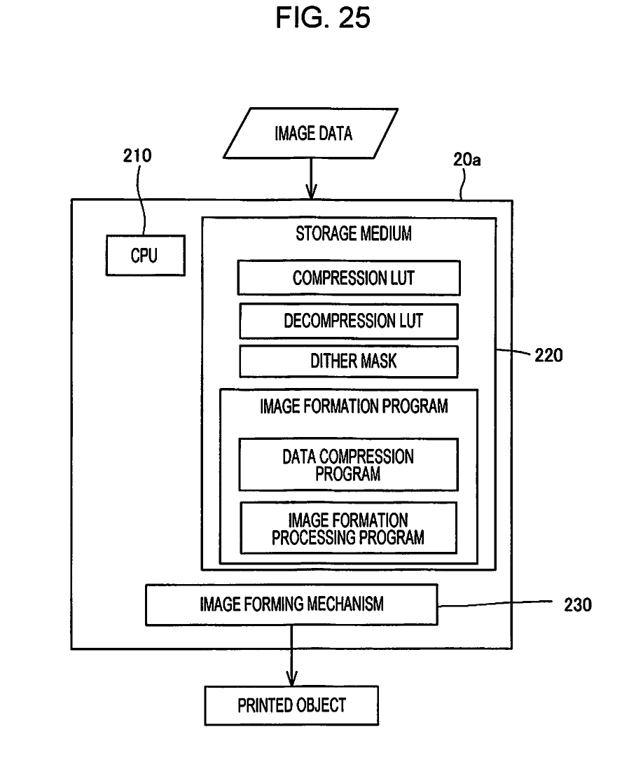

FIG. 25 shows an overview of a printer 20a. The printer 20a functions in the same manner as the image forming system 20 in stand-alone by performing the color conversion (S300) and a data compression program (S400). Therefore, the printer 20a configures the image forming system in a broad sense. Furthermore, the printer 20a functions as a data compression device or a data compression system. A data compressing process program and an image formation processing program are collectively referred to as an image formation program.

### Embodiment 4

In the embodiment, all blocks are processed as the block having the edge without distinguishing the presence or absence of the edge within the block. That is, in the data compressing process, determination of S420 is abolished and S445 to S490 are performed for all blocks. Therefore, the flag is not necessary. Then, in the halftone process, determination of S515 is abolished and S540 to S560 are performed for all blocks.

In a case where all pixels within the block have the same gradation value, when an average value or more in S445 is set as the H value group, since all pixels are classified as the H value group, a subsequent process of the L value group may be omitted. In a case of not omitted, since the dot arrangement of the L value group is not reflected in any pixel at the time of the synthesis, the representative value of the L value group may be treated as an appropriate value such as 0.

As a modification example of the embodiment 4, the generation of the dot data may be performed by the data compression device 100 and the generated dot data may be transmitted to the printer 200.

In a case of the embodiment, there is an advantage that the conditional branching is reduced and the process is simplified by performing the same process on all blocks compared to the embodiment 1. Especially, in a case where the processes of the L value group and the H value group processed as hardware are performed in parallel, or the like, it is effective without a reduction in speed.

The data compressing process can be performed with a combination of the method of the embodiment 1 that different processes are performed on the block including the edge and the block not including the edge in FIG. 3, and the halftone process can also be performed with a combination of the method of the embodiment 4 that all blocks are processed as the block including the edge. In this case, the block not including the edge, all pixels may be processed as the H value group in the halftone process, and the representative value of the L value group may be set to an appropriate value such as 0. In this method, it is possible to achieve both of the high compression ratio of the embodiment 1 and the simple method suitable for hardware implementation of the embodiment 4.

The present disclosure is not limited to the embodiments, examples, and modified examples of the present specification, and can be realized in various configurations without departing from the gist thereof. For example, in order to solve part or all of the above-mentioned problems, the technical features in the embodiments, examples, and modifications corresponding to the technical features in each embodiment described in the Summary of the Invention, or in order to achieve some or all of the effects, it is possible to replace or combine as appropriate. Unless its technical features are described as essential here, it can be deleted as appropriate. For example, the following are exemplified.

In a case where a plurality of the block gradation values is decided with respect to the same block, the number of values to be decided may be more than two of the H value group and the L value group. However, it is preferable that the number Nt of values to be decided be smaller than Nb (the number of pixels configuring one block). That is, it is preferable that Nb>Nt. For example, in a case of Nb=8, it may be set to Nt=3, and a case of Nt=2 and a case of Nt=3 may be changed according to the gradation value of the image data within the block.

In addition, other modification examples will be mentioned.

Data obtained by compression in a first stage may be transferred. That is, the H value group and the representative value of the L value group, and the position information may be transferred.

A determining method of the presence or absence of the edge, and a classifying method of the H value group and the L value group may be appropriately changed. For example, as the classification method of the H value group and the L value group, a fixed value (gradation value 128) may be the threshold value instead of an average of the maximum gradation value and the minimum gradation value.

The representative value may be decided by a method other than the sum total. For example, geometric mean, median or mode may be used. Alternatively, the highest gradation value within the block may be set as the representative value of the H value group, and the lowest gradation value within the block may be used as the representative value of the L value group. In this method, an edge emphasizing effect is obtained.

Instead of deciding the block gradation value after deciding the representative value, by obtaining the block gradation value for each of a plurality of pixels and deciding the representative values of a plurality of block gradation values, the block gradation value of each of the H value group and the L value group may be decided.

In order to temporarily decide the dot arrangement from a combination of the number of the dots (S530 and S545), the dither mask or the density pattern method may be not used. For example, it may be randomly arranged.

Based on the block gradation value, a method (S540 and S550 in the embodiment) of temporarily deciding the dot arrangement may be changed. For example, by one reference of the LUT, temporary decision of the dot arrangement from the block gradation value may be performed. In FIG. 8, the LUT is prepared for each position of the block and corresponds to a corresponding portion from the representative value to the upper four-pixel dot arrangement and the lower four-pixel dot arrangement, and the block gradation value and the dot arrangement correspond thereto. In this modification example, although the data amount of the decompression LUT increases, the processing for dot arrangement becomes faster.

As another method of temporarily deciding the dot arrangement, by referring to the LUT once, the block gradation value may be converted into ON dot number correspondence data indicating a combination of the number of ON dots of each size of the large, medium, and small dots, and by obtaining the number of ON dots of each size of the large, medium, and small dots from the ON dot number correspondence data, S550 described as the embodiment may be performed. In a case where Nb is eight, there are 165 combinations of the number of ON dots of three types of large, medium, and small dots. If an ON dot number correspondence LUT obtained by corresponding the ON dot number correspondence data from 0 to 164 and combinations of the number of ON dots of 165 types one by one are created, the ON dot number correspondence data can be returned to the ON dot number data by referring the ON dot number correspondence LUT. Since the ON dot number correspondence data can be stored in eight bits, it is possible to decrease a data size more than the data size of the ON dot number data of the three types of large directly described.

The data amount of the block gradation value may be changed as appropriate. For example, the data amount may be changed the number of pixels according to configuring the block. In a case of one block and 16 pixels, in most cases, the maximum value of the block gradation value is 63 or less. In this case, the data amount of the block gradation value is sufficient for six bits. In addition, in the case of four pixels per block, the maximum value of the block gradation value in most cases is 15 or less. In this case, four bits for the data amount of the block gradation value are sufficient.

In the embodiment 1, the halftone process in which all blocks are converted into the second compressed data and the final dot arrangement is obtained is performed, but these processing units may have a smaller number of blocks. For example, the halftone process may be performed after conversion into the second compressed data in the horizontal direction for all blocks and the vertical direction for one block unit. Also, in this case, the effects of (a) to (e) described in the embodiment 1 are effective.

The conversion to compressed data and the halftone process may be continued in units of one block. In this case, although the effect of (c) is lost, since the effects of (a) and (b) remain, it is a sufficiently useful technology.

The mask of the L value group may be omitted. In this case, the dot arrangement of the H value after the mask is synthesized with the dot arrangement of the L value group which is not masked. In this manner, processing load is reduced. The dots of the H value after the mask are arranged in the pixel in which the dots are arranged in both the dot arrangement of the H value after the mask and the dot arrangement of the L value group. In this method, it is a condition that a method in which dots with a large size are preferentially formed at pixel positions with a small threshold value as shown in S530 for the halftone process is used and the total number of large, medium, and small dots monotonically increase with respect to a block gradation value.

In the embodiment, part or all of the functions and processes realized by the software may be realized by hardware. In addition, some or all of the functions and processes realized by the hardware may be realized by software. As the hardware, for example, various circuits such as an integrated circuit, a discrete circuit, or a circuit module combining these circuits may be used.

As described in the embodiment 1, in a form of changing a method of deciding the dot arrangement based on the presence or absence of the edge, after the dot arrangement is temporarily decided with respect to the H value group and the L value group regarded as having the edge for all blocks, in a case where all pixels within the block are included in one of H or L group, the dot arrangement may be decided by ignoring a temporary decided result for a group not including in one pixel. Since such conditional branching can be reduced by such a method, it is practical in a case where it is realized by hardware.

In the additional process, among the pixels within the block, the dot may be formed on the pixel having the largest gradation value. This is because when the dot is formed on the pixel having the largest gradation value, the dot tends to be formed at a portion where the gradation value is high in the original image data. Alternatively, the pixels within the block may include the pixel of the L value group, and may be randomly decided.

In the additional process, the number of the dots to be added may be any number as long as it is equal to or less than the number of pixels decided that there is no the dot formation, in the dot arrangement decided in S530 or S560.

Calculation of an error in the error diffusion method (S640) and diffusion of the calculated error (S650) may not be used with the block as a unit. For example, the pixel may be used as a unit.

Whether or not to add the dot is determined by the error diffusion method (S606) is not limited to a case where the number of the dots indicated by the dot arrangement decided in S530 or S560 is zero, that is, a case where it is equal to or less than zero. For example, it may be determined in a case where the number of the dots indicated by the dot arrangement is equal to or less than a predetermined number. The predetermined number is an arbitrary natural number equal to or less than (Nb−1) pieces.

This application claims priority under 35 U.S.C. § 119 to Japanese Patent Application No. 2017-046304, filed Mar. 10, 2017. The entire disclosure of Japanese Patent Application No. 2017-046304 is hereby incorporated herein by reference.

What is claimed is:

1. An image forming system comprising:
a classifying unit that classifies a block configured with Nb pixels included in image data as a target into Nt (Nt is integer satisfying 2≤Nt<Nb) groups including a group including a pixel of the highest gradation value and a group including a pixel of the lowest gradation value;
a position information creating unit that creates position information which is information indicating a position of the pixel configuring a group with respect to at least one of the Nt groups;
a block gradation value deciding unit that decides a block gradation value by a data amount smaller than a data amount required for representing gradation values of the Nb pixels based on the gradation value for each pixel configuring each group, for each of the Nt groups as the target;
a temporary deciding unit that temporarily decides dot arrangement which is information indicating the presence or absence of dot formation for each pixel configuring the block based on the block gradation value, for each of the Nt groups as the target;
a dot arrangement deciding unit that decides the dot arrangement targeting the block by using the temporarily decided dot arrangement and the position information;
a determining unit that determines whether or not the dot arrangement decided by the dot arrangement deciding unit is corrected by using an error diffusion method;
a correcting unit that corrects the dot arrangement in a case where it is determined by the determining unit that the dot arrangement is corrected; and
an image forming unit that forms an image by using the dot arrangement.

2. The image forming system according to claim 1,
wherein the determining unit performs calculation of an error and diffusion of the calculated error in the error diffusion method with the block as a unit.

3. The image forming system according to claim 1,
wherein the determining unit performs the determination in a case where the number of the dots included in the dot arrangement decided by the dot arrangement deciding unit is equal to or less than a predetermined number.

4. The image forming system according to claim 1,
wherein the correcting unit selects a pixel in which a dot is arranged from pixels included in a group including the pixel of the highest gradation value.

5. The image forming system according to claim 4,
wherein the correcting unit randomly selects arrangement of the dot in a pixel from the pixels included in the group including the pixel of the highest gradation value.

6. The image forming system according to claim 1,
wherein the determining unit determines whether or not the dots are arranged with respect to at least one pixel in which it is decided by the dot arrangement deciding unit that there is no dot formation, and
the correcting unit corrects the dot arrangement by arranging the dot with respect to at least one pixel in which it is decided that there is no dot formation in a case where it is determined by the determining unit that the dot is arranged.

7. An image forming apparatus comprising:
a classifying unit that classifies a block configured with Nb pixels included in image data as a target into Nt (Nt is integer satisfying 2≤Nt<Nb) groups including a group including a pixel of the highest gradation value and a group including a pixel of the lowest gradation value;
a position information creating unit that creates position information which is information indicating a position of the pixel configuring a group with respect to at least one of the Nt groups;
a block gradation value deciding unit that decides a block gradation value by a data amount smaller than a data amount required for representing gradation values of the Nb pixels based on the gradation value for each pixel configuring each group, for each of the Nt groups as the target;
a temporary deciding unit that temporarily decides dot arrangement which is information indicating the presence or absence of dot formation for each pixel configuring the block based on the block gradation value, for each of the Nt groups as the target;
a dot arrangement deciding unit that decides the dot arrangement targeting the block by using the temporarily decided dot arrangement and the position information;
a determining unit that determines whether or not the dot arrangement decided by the dot arrangement deciding unit is corrected by using an error diffusion method;
a correcting unit that corrects the dot arrangement in a case where it is determined by the determining unit that the dot arrangement is corrected; and
an image forming unit that forms an image by using the dot arrangement.

8. An image forming method comprising:
classifying a block configured with Nb pixels included in image data as a target into Nt (Nt is integer satisfying 2≤Nt<Nb) groups including a group including a pixel of the highest gradation value and a group including a pixel of the lowest gradation value;
creating position information which is information indicating a position of the pixel configuring a group with respect to at least one of the Nt groups;
deciding a block gradation value by a data amount smaller than a data amount required for representing gradation values of the Nb pixels based on the gradation value for each pixel configuring each group, for each of the Nt groups as the target;
temporarily deciding dot arrangement which is information indicating the presence or absence of dot formation for each pixel configuring the block based on the block gradation value, for each of the Nt groups as the target;
deciding the dot arrangement targeting the block by using the temporarily decided dot arrangement and the position information;
determining whether or not the decided dot arrangement is corrected, by using an error diffusion method;
correcting the dot arrangement in a case where it is determined that the dot arrangement is corrected; and
forming an image by using the dot arrangement.
